(19) United States
(12) Patent Application Publication
(10) Pub. No.: US 2007/0010300 A1
(43) Pub. Date: Jan. 11, 2007

(54) WIRELESS TRANSCEIVING MODULE WITH MODULARIZED CONFIGURATION AND METHOD THEREOF

(76) Inventors: Hongxi Xue, Irvine, CA (US); Yi-Li Cheng, Tai-Chung City (TW); Min-Chuan Wu, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/160,769

(22) Filed: Jul. 8, 2005

(51) Int. Cl. H04B 1/26; H04M 1/00

(52) U.S. Cl. 455/575.5

(57) ABSTRACT

A wireless transceiving module includes an antenna, a signal processing unit and a shielding case. The antenna is used for transceiving an RF signal, and has a signal point. The signal processing unit is coupled to the signal point for processing the RF signal, and has an RF circuit coupled to the antenna and a baseband circuit for converting a first baseband signal into a first RF signal and for converting a second RF signal into a second baseband signal. The shielding case is used for electromagnetically shielding the signal processing unit, and the shielding case acts as a ground plane for the antenna.

### BACKGROUND

The present invention relates to a wireless communication device, and more particularly, to a wireless transceiving device with a modularized configuration and a method thereof.

Modern day communication systems such as mobile phones and GPS tracking systems are becoming more and more complex as technology develops. Consumers want smaller devices that still maintain good reception, high overall performance and large frequency range. Circuit arrays are crucially important at RF frequencies, as interference from various components can hinder or block reception of signals. As equipment is miniaturized, the receptors and sources of electromagnetic interference (EMI) are in closer proximity than before, and the chances of interference are greater. The current challenge faced by manufacturers, therefore, is integrating RF circuits into the whole device without sacrificing performance.

Please refer to FIG. 1. FIG. 1 is a perspective diagram of the internal configuration of a related art transceiver 10. The transceiver 10 includes at least a baseband circuit 12, which converts digital data into baseband signals for transmission and converts received baseband signals into digital data; at least an RF circuit 14, which converts the baseband signals for transmission into RF signals and converts received RF signals into baseband signals; and an antenna 16 for transceiving RF signals. The baseband and RF circuits are contained in a shielding case, for shielding the baseband and RF circuits from electromagnetic interference (EMI). As shown in FIG. 1, a printed circuit board (PCB) 20 is implemented to load above-mentioned components and interconnect circuit components.

In the related art, each component is manufactured separately and then integrated by parts to form the whole device. Because the placing and layout of the components has a direct effect on the performance of the whole system, a transceiver may have to be redesigned at a late stage in the development process. Moreover, the cost of integrating the components separately is expensive.

### SUMMARY

It is therefore one of the objectives of the claimed invention to provide a configuration of a wireless transceiving module and a method thereof, to solve the above-mentioned problem.

Briefly described, the present invention discloses a wireless transceiving device with a modularized configuration, comprising a plurality of baseband circuits, a plurality of RF circuits, and a planar antenna, wherein the baseband circuits and RF circuits are contained in a shielding case, which acts as the ground connection for the antenna. The planar antenna and the shielding case containing RF and baseband circuits are positioned in a modular configuration; in other words, the planar antenna is positioned on top of the shielding case.

It is an advantage of the present invention that the entire transceiving device can be manufactured as one integrated structure, thereby greatly reducing uncertainties incurred when parts are manufactured separately. It is a further advantage that the cost of manufacturing is thereby reduced. Additionally, the positioning of the antenna with regards to the shielding case ensures that interference caused by RF radiation is still prevented.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective diagram of the internal configuration of a related art transceiver.

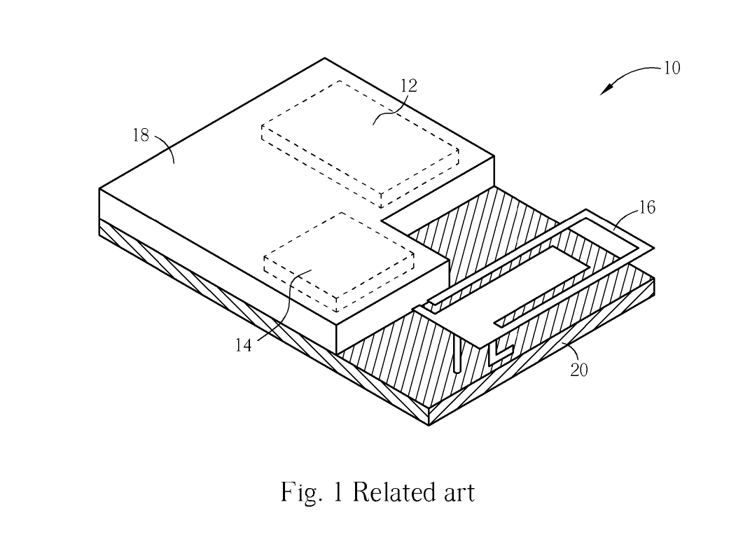

FIG. 2 is perspective diagram of a wireless transceiving module according to a first embodiment of the present invention.

FIG. 3 is a section view of the wireless transceiving module shown in FIG. 2.

### DETAILED DESCRIPTION

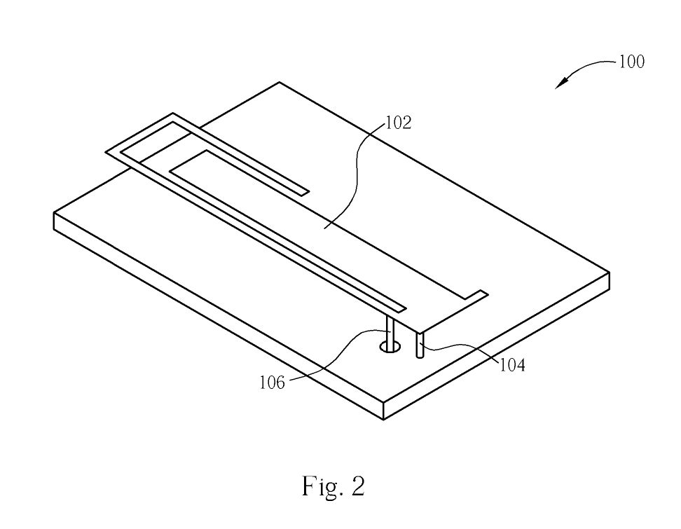

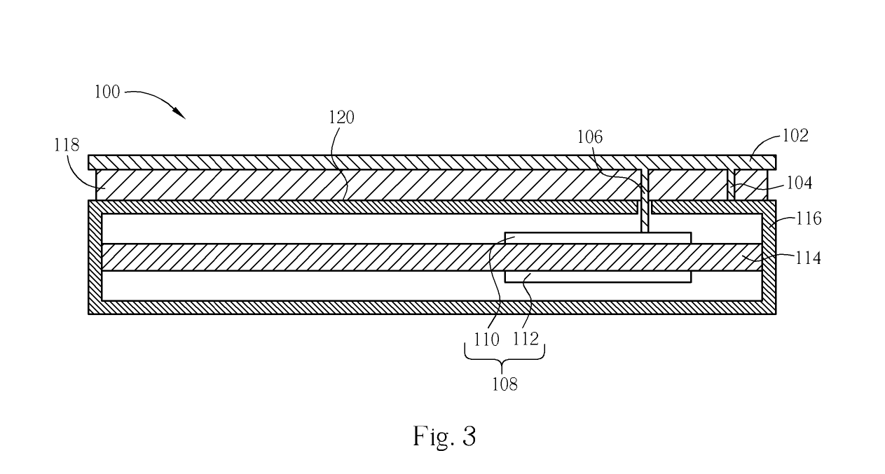

Please refer to FIG. 2 in conjunction with FIG. 3. FIG. 2 is a perspective diagram of a wireless transceiving module 100 according to a first embodiment of the present invention. FIG. 3 is a section view of the wireless transceiving module 100 shown in FIG. 2. In this embodiment, the wireless transceiving module 100 is applied to a portable electronic device (e.g. a mobile phone), and comprises an antenna 102, a signal processing unit 108, a first printed circuit board 114, a second printed circuit board 118, and a shielding case 116. The antenna 102 is used for transceiving an RF signal, where the antenna 102 has a ground point 104 and a signal point 106. The signal processing unit 108 is coupled to the signal point 106 for processing the RF signal, comprising an RF circuit 110 coupled to the antenna 102, for converting a first baseband signal into a first RF signal, and for converting a second RF signal into a second baseband signal; and a baseband circuit 112 coupled to the RF circuit 110 through the printed circuit board 114, for converting a first digital data into the first baseband signal, and for converting the second baseband signal into a second digital data. The signal processing unit 108 is positioned on the first printed circuit board 114 and contained in the shielding case 116, which is used for electro-magnetically shielding the internal circuits from external radiated RF signals or noise. Superimposed on the second printed circuit board 118 is a ground plane 120 forming one side of the shielding case, where the antenna is superimposed on the other side of the printed circuit board. This enables the antenna to be supported by the second printed circuit board 118. As shown in FIG. 3, the ground point 104 of the antenna 102 is connected to the shielding case 116. Because the antenna 102 is positioned on top of the shielding case 116, the shielding case 116 further acts as a ground plane for the antenna 102.

In this embodiment, the antenna 102 is a Planar Inverted F Antenna (PIFA), so called because the shape is similar to the letter F, with the two shorter sections as the signal point 106 and ground point 104 respectively. The antenna 102 could be implemented by other planar antennas, however. For example, in a second embodiment of the present invention, the PIFA antenna in the first embodiment is replaced with a PATCH antenna, having a centrally situated signal point connected to the signal processing unit. Similarly, the PATCH antenna is positioned on top of the shielding case. In this case, the shielding case acts as the ground plane for the antenna. The PATCH antenna itself does not have a ground point, however the shielding case acts as a ground plane for the antenna in both cases. The configuration and function of the second embodiment is therefore largely similar to that of the first embodiment and further discussion is thus omitted for brevity. Please note that any planar antenna may be used and the PATCH and PIFA antennae are merely embodiments of the present invention, rather than limitations.

Please note that the RF circuit 110 and the baseband circuit 112 shown in FIG. 3 are positioned on different sides of the first printed circuit board 114. Therefore, the shielding case 116 has to envelope both sides of the first printed circuit board 114. If all of the circuit components are positioned on one side of the first printed circuit board 114, however, the shielding case 116 is allowed to merely envelope one side of the first printed circuit board 114.

As mentioned above, the configuration of the antenna 102 and the signal processing unit 108 is capable of transceiving RF signals. The antenna 102 and the signal processing unit 108 can also be properly designed and configured to function as a wireless receiving module for receiving RF signals and processing the received RF signals, or a wireless transmitting module for processing data and transmitting RF signals related to the processed data. In other words, the above-mentioned integration of the antenna 102, the shielding case 116 and the signal processing unit 108 could be applied to manufacturing a wireless transceiving module, a wireless transmitting module and a wireless receiving module.

The present invention allows the entire transceiving device to be manufactured as a modularized device, reducing errors incurred when parts are manufactured separately due to interference from nearby components. The present invention also allows for greater flexibility of design as the modularized configuration can be built to any specification. Furthermore, the cost involved in producing the modulated system as opposed to producing a system by parts is reduced. In short, the advantages of the present invention are greater flexibility, economy and accuracy.

Those skilled in the art will readily observe that numerous modifications and alterations of the device and method may be made while retaining the teachings of the invention. Accordingly, the above disclosure should be construed as limited only by the metes and bounds of the appended claims

What is claimed is:

1. A wireless transceiving module, comprising:
an antenna for transceiving an RF signal, the antenna comprising a signal point;
a signal processing unit coupled to the signal point for processing the RF signal, the signal processing unit comprising:
an RF circuit coupled to the antenna and a baseband circuit for converting a first baseband signal into a first RF signal, and for converting a second RF signal into a second baseband signal; and
a shielding case for electromagnetically shielding the signal processing unit, wherein the antenna is positioned on top of the shielding case, which acts as a ground plane for the antenna.

2. The wireless transceiving module of claim 1 wherein the signal processing unit further comprises:
a baseband circuit for converting a first digital data into the first baseband signal, and for converting the second baseband signal into a second digital data.

3. The wireless transceiving module of claim 1 wherein the antenna is a planar antenna.

4. The wireless transceiving module of claim 3 wherein the planar antenna is a PIFA antenna.

5. The wireless transceiving module of claim 3 wherein the planar antenna is a patch antenna.

6. The wireless transceiving module of claim 4 wherein the antenna further comprises a ground point, which is connected to the shielding case.

7. The wireless transceiving module of claim 1 being applied to a portable electronic device.

8. The wireless transceiving module of claim 3, further comprising a printed circuit board (PCB) wherein the planar antenna is superimposed on one side of the PCB and a ground plane is superimposed on the other side, and the ground plane is one plane of the shielding case.

9. A wireless receiving module, comprising:
an antenna for receiving an RF signal, the antenna comprising a signal point;
a signal processing unit coupled to the signal point for processing the RF signal, the signal processing unit comprising:
an RF circuit coupled to the antenna for converting the RF signal into a baseband signal; and
a shielding case for electromagnetically shielding the signal processing unit, wherein the antenna is positioned on top of the shielding case, which acts as a ground plane for the antenna.

10. The wireless receiving module of claim 9 wherein the signal processing unit further comprises a baseband circuit for converting the baseband signal into a digital data.

11. The wireless receiving module of claim 9 wherein the antenna is a planar antenna.

12. The wireless receiving module of claim 11 wherein the antenna further comprises a ground point, which is connected to the shielding case.

13. The wireless receiving module of claim 11, further comprising a printed circuit board (PCB) wherein the planar antenna is superimposed on one side of the PCB and a ground plane is superimposed on the other side, and the ground plane is one plane of the shielding case.

14. A wireless transmitting module, comprising:
an antenna for transmitting an RF signal, the antenna comprising a signal point;
a signal processing unit coupled to the signal point for processing the RF signal, the signal processing unit comprising:
an RF circuit coupled to the antenna and a baseband circuit for converting a baseband signal into the RF signal; and
a shielding case coupled to the ground point for electromagnetically shielding the signal processing unit, wherein the antenna is positioned on top of the shielding case, which acts as a ground plane for the antenna.

15. The wireless transmitting module of claim 14 wherein the signal processing unit further comprises a baseband circuit for converting a digital data into the baseband signal.

16. The wireless transmitting module of claim 14 wherein the antenna is a planar antenna.

17. The wireless transmitting module of claim 16 wherein the antenna further comprises a ground point, which is connected to the shielding case.

18. The wireless transmitting module of claim 16, further comprising a printed circuit board (PCB) wherein the planar antenna is superimposed on one side of the PCB and a ground plane is superimposed on the other side, and the ground plane is one plane of the shielding case.

19. A method of forming a wireless transceiving module, comprising:
providing an antenna and utilizing the antenna for transceiving a wireless signal;
providing a signal processing unit and utilizing the signal processing unit for processing the wireless signal; and
providing a shielding case, utilizing the shielding case for housing the signal processing unit, and positioning the antenna on top of the shielding case, which acts as a ground plane for the antenna.

20. The method of claim 19 wherein the antenna is a planar antenna.

21. The method of claim 20 wherein the antenna further comprises a ground point and the method further comprises:
connecting the ground point of the antenna to the shielding case.

22. The method of claim 20, wherein the method further comprises providing a printed circuit board (PCB), superimposing the planar antenna on one side of the printed circuit board, and superimposing a ground plane on the other side of the printed circuit board, where the ground plane is one plane of the shielding case.
